(19) United States
(12) Patent Application Publication
(10) Pub. No.: US 2021/0097458 A1
(43) Pub. Date: Apr. 1, 2021

(54) DETERMINATION OF A LIFT COUNT METRIC

(71) Applicant: Caterpillar Inc., Peoria, IL (US)

(72) Inventors: Chad T. Brickner, Dunlap, IL (US); Allen John DeClerk, Princeton, IL (US); Bradley Keith Bomer, Pekin, IL (US); Mark William Whiting, Peru, IL (US)

(73) Assignee: Caterpillar Inc., Peoria, IL (US)

(21) Appl. No.: 16/589,867

(22) Filed: Oct. 1, 2019

(51) Int. Cl. G06Q 10/06

(52) U.S. Cl. CPC G06Q 10/0639

(57) ABSTRACT

A method of estimating productivity at a worksite includes receiving, with a controller, a worksite plan to be executed by a hauling machine, a spreading machine, and a compacting machine at the worksite, assigning, with the controller, the hauling machine, the spreading machine, and the compacting machine to implement tasks within the worksite plan based on respective capabilities of the hauling machine, the spreading machine and the compacting machine, receiving, with the controller, machine data from the hauling machine, the spreading machine and the compacting machine defining indication of completion of the tasks, and calculating, with the controller, a lift count based on the machine data.

### TECHNICAL FIELD

The present disclosure relates to systems and methods for determining the level of completion of a worksite plan. More specifically, the present disclosure relates to systems and methods for calculating a machine lift count based on machine data and using the lift count to determine a corresponding level of completion.

### BACKGROUND

Haul trucks, wheel loaders, skid steer loaders, dozers, and other machines are often used to perform a variety of tasks at a worksite. These digging units, loading units, hauling units, material spreading units, grading units, and compacting units, among other types of machines, may be used to excavate and prepare an area of ground for further development and building. For example, one or more hydraulic excavators, may be used to remove a layer of material such as soil, gravel, concrete, asphalt, or other material making up part of a work surface at the worksite. In some examples, an articulated truck or on-highway truck may be used as a hauling unit to move the material excavated by the hydraulic excavators away from or to the worksite. Further, in some examples, a track type tractor (TTT) may be used to create an elevation, slope, and grade of the material along a surface of the worksite. A soil compactor acting as a compacting unit may be used to compact the material to an intended density of the material. In some examples, a finish grade may be applied to the material across the worksite. The process using the machines described above may be referred to herein as “mass excavation.”

An example system for use in tracking and monitoring a plurality of machines is described in U.S. Pat. No. 5,956,250 A (hereinafter referred to as the '250 reference). In particular, the '250 reference describes a system and method for controlling the navigation of surface-based vehicle uses a route that is obtained by manually driving the vehicle over the route to collect data defining the absolute position of the vehicle at various positions along the route. The collected data is smoothed to provide a consistent route to be followed. The smoothed data is subsequently used to automatically guide the vehicle over the route.

The '250 reference does not describe defining and counting certain events in order to determine a percentage or level of completion of a worksite plan and does not define a “lift count” used to assist in such a determination. The types of machines used in the mass excavation may report production metrics of different types. These different production metrics for the different machines are not useful in reporting an overall completion percentage or level of the worksite plan in which the machines complete a plurality of different tasks. Further, because the different machines report different production metrics, it may be difficult to obtain insight into which machines within the worksite are underperforming within the overall worksite plan.

At a given construction site, a construction control authority may be responsible for managing a construction assignment that is completed by several distinct sets of equipment working at a remote location. From the construction assignment management perspective, location data associated with a given set of equipment can be a measure of accessing performance of the given set of equipment. However, each set of equipment may not have the location identification capabilities or the performance computation capabilities. At best, only some of the sets of equipment may have high precision Global Positioning Systems (GPS) for providing accurate elevation data. Even with high accuracy GPS, elevation margin of error may be high enough to create uncertainty regarding location data. In other words, high accuracy GPS data may provide accurate latitude and longitude values, but the margin of error within an elevational measurement may be high enough to may individual lift detection difficult in terms of accuracy. In the examples described herein, and industry standard for a single lift may be approximately 300 mm in elevation. Accordingly, gathering equipment performance data can be a tedious process mandating manually tracking location of each set of equipment, and manually initiating a corrective action for an underperforming set of equipment, whereby the underperforming equipment may be repaired, replaced or reallocated. Examples of the present disclosure are directed toward overcoming the deficiencies described above.

### SUMMARY

In an example of the present disclosure, a method of estimating productivity at a worksite includes receiving, with a controller, a worksite plan to be executed by a hauling machine, a spreading machine, and a compacting machine at the worksite, assigning, with the controller, the hauling machine, the spreading machine, and the compacting machine to implement tasks defined by the worksite plan based on respective capabilities of the hauling machine, the spreading machine and the compacting machine, receiving, with the controller, machine data from the hauling machine, the spreading machine, and the compacting machine, the machine data being indicative of a first level of completion corresponding to a first task being performed by the hauling machine, a second level of completion corresponding to a second task being performed by the spreading machine, and a third level of completion corresponding to a third task being performed by the compaction machine, and determining, with the controller, a lift count based on the machine data.

In another example of the present disclosure, a system for measuring productivity across different types of machines includes a controller, a first machine of a first type operable at a worksite to perform a first task defined by a worksite plan, at least a second machine of a second type operable at the worksite to perform a second task defined by the worksite plan; and a communication network configured to transmit signals between the controller and the first machine and the second machine. The controller is configured to receive, from a first sensor associated with the first machine, first machine telematics data defining an indication of completion of the first task from the first machine, receive, from a second sensor associated with the second machine, second machine telematics data defining an indication of completion of the second task from the second machine, and determine a lift count based on the first machine telematics data and the second machine telematics data, the lift count defining a percentage of completion of the worksite plan.

In yet another example of the present disclosure, a system for determining a percentage of completion of a worksite plan includes a controller, and a communication network communicatively coupled to the controller to transmit signals between the controller and a plurality of machines. The controller receives, from a first sensor associated with a first machine, first machine data defining an indication of completion of a first task, receives, from a second sensor associated with at least a second machine, second machine data defining an indication of completion of a second task, and determines a lift count based on the first machine data and the second machine data, the lift count defining a percentage of completion of the worksite plan.

### BRIEF DESCRIPTION OF DRAWINGS

FIG. 1 is a schematic illustration of a system in accordance with an example of the present disclosure.

FIG. 2 is a flow chart depicting an example method associated with the system shown in FIG. 1.

FIG. 3 is a flow chart depicting an example method associated with the systems and methods shown in FIGS. 1 and 2.

FIG. 4 is a flow chart depicting another example method associated with the systems and methods shown in FIGS. 1 and 2.

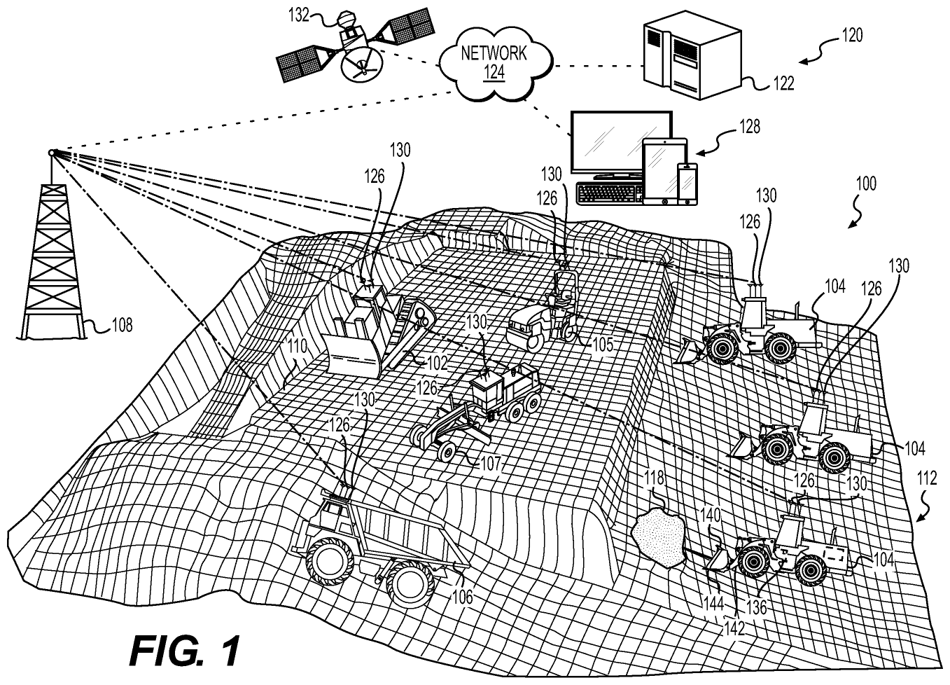

### DETAILED DESCRIPTION

Wherever possible, the same reference numbers will be used throughout the drawings to refer to the same or like parts. Referring to FIG. 1, an example system 100 may include one or more machines operating at a worksite 112 to perform various tasks. For example, the system 100 may include one or more digging machines 102, one or more loading machines 104, one or more compacting machines 105, one or more hauling machines 106, one or more grading machines 107 and/or other types of machines used for construction, mining, paving, excavation, and/or other operations at the worksite 112. The machines described herein may be in communication with each other and/or with a local or remote control system 120 by way of one or more central stations 108. The central station 108 may facilitate wireless communication between the machines described herein and/or between such machines and, for example, a system controller 122 of the control system 120, for the purpose of transmitting and/or receiving operational data and/or instructions. In the examples described herein, the system controller 122 may cause and/or instruct the machines 102, 104, 105, 106, 107 to perform their respective tasks as described herein in an autonomous and/or semi-autonomous manner by sending instructions to the respective controllers 136 of the machines 102, 104, 105, 106, 107 via the network 124, the satellite 132 and/or the central stations 108, and communication devices 126 of the respective machines 102, 104, 105, 106, 107. While only a single controller 136 is illustrated schematically in FIG. 1, it is understood that each of the machines 102, 104, 105, 106, 107 described herein may include a respective controller 136. The controllers 136 of the machines 102, 104, 105, 106, 107 may execute the instructions as received from the system controller 122 to cause the machines 102, 104, 105, 106, 107 to perform the tasks as defined by the instructions.

A digging machine 102 may refer to any machine that reduces material at the worksite 112 for the purpose of subsequent operations (i.e., for blasting, loading, hauling, and/or other operations). Examples of digging machines 102 may include excavators, backhoes, dozers, drilling machines, trenchers, and drag lines, among other types of digging machines. Multiple digging machines 102 may be co-located within a common area at the worksite 112 and may perform similar functions. For example, one or more of the digging machines may move soil, sand, minerals, gravel, concrete, asphalt, overburden, and/or other material (collectively referred to herein as soil or material) comprising at least part of a work surface 100 of the worksite 112. As such, under most conditions, similar co-located digging machines 102 may perform about the same with respect to productivity and efficiency when exposed to similar site conditions.

A loading machine 104 may refer to any machine that lifts, carries, loads, and/or removes material that has been reduced by one or more of the digging machines 102. In some examples, a loading machine 104 may remove such material, and may transport the removed material from a first location at the worksite 112 to a second location at the worksite 112 or off or onto the worksite. Examples of a loading machine 104 may include a wheeled or tracked loader, a front shovel, an excavator, a cable shovel, and a stack reclaimer, among other types of loading machines 104. One or more loading machines 104 may operate within common areas of worksite 112 to, for example, load reduced materials onto a hauling machine 106.

A hauling machine 106 may refer to any machine that carries the excavated materials between different locations within worksite 112. Examples of hauling machines 106 may include an articulated truck, an off-highway truck, an on-highway dump truck, and a wheel tractor scraper, among other types of hauling machines 106. Laden hauling machines 106 may carry overburden from areas of excavation within worksite 112, along haul roads to various dump sites, and return to the same or different excavation areas to be loaded again. Under some conditions, similar co-located hauling machines 106 may perform about the same with respect to productivity and efficiency when exposed to similar site conditions.

A compacting machine 105 may refer to any machine that is configured to apply stress on a work surface 110 of the worksite 112 and cause densification of soil thereon and/or obtains an acceptable surface finish. An operation of the soil compacting machine 105 may immediately follow operation of a soil grading machine 107 and/or may immediately proceed operation of a soil grading machine 107. In one example, the compacting process may be performed with a compacting machine 105 such as a double drum compacting machines, having a front drum and a back drum, which serve to propel the machine and compact the material to a suitable state via the weight of the compacting machine, and may be used in cooperation with drum vibrating apparatuses. Other examples of soil compacting machines 105 may include a wheeled or tracked soil compactor, a vibratory soil compactor, and a tandem vibratory compactor among other types of compacting machines 105. One or more soil compacting machines 105 may co-operate within the worksite 112 to compact soil thereon. Completing compaction may include multiple passes across the material with the compacting machine.

A grading machine 107 may refer to any machine that is configured to create a flat surface by grading material such as soil at the worksite 112 for subsequent operations, for example, for a compacting operation. Examples of soil grading machines 107 may include scrapers, bulldozers, motor graders or other similar machines commonly known in the art to create a flat surface during operation. Multiple soil grading machines 107 may be co-located within a common area of the worksite 112 and may perform similar functions.

With continued reference to FIG. 1, the system 100 may include the control system 120 and the system controller 122 to control and/or coordinate data transmission between various elements within the system 100. In some examples the control system 120 and/or the system controller 122 may be located at a command center (not shown) remote from the worksite 112. In other examples, the system controller 122 and/or one or more components of the control system 120 may be located at the worksite 112. Regardless of the location of the various components of the control system 120, such components may be configured to facilitate communications between, and to provide information to, the digging machines 102, loading machines 104, hauling machines 106, compacting machines 105, grading machines 107, and/or other machines of the system 100. In any of the examples described herein, the functionality of the system controller 122 may be distributed so that certain operations are performed at the worksite 112 and other operations are performed remotely such as, for example, at the remote command center noted above. For example, some operations of the system controller 122 may be performed at the worksite 112, on one or more of the digging machines 102, one or more of the loading machines 104, one or more of the hauling machines 106, one or more of the compacting machines 105, or one or more of the grading machines 107, among other locations and devices of the system 100. It is understood that the system controller 122 may comprise a component of the system 100, a component of one or more of the machines disposed at the worksite 112, a component of a separate mobile device such as, for example, a mobile phone, a tablet, and a laptop computer, among other types of mobile devices, and/or the control system 120.

The system controller 122 may be an electronic controller that operates in a logical fashion to perform operations such as execute control algorithms, store and retrieve data, and other similar operations. The system controller 122 may additionally include any other components required for running an application including but not limited to access memory, secondary storage devices, processors, and the like. The memory and secondary storage devices may be in the form of read-only memory (ROM), random access memory (RAM) or integrated circuitry that is accessible by the controller. Various other circuits may be associated with the system controller 122 including but not limited to power supply circuitry, signal conditioning circuitry, driver circuitry, and other types of circuitry.

The system controller 122 may be a single controller or may include more than one controller. In examples where the system controller 122 includes more than one controller, the system controller 122 may, for example, include additional controllers associated with the digging machines 102, loading machines 104, hauling machines 106, compacting machines 105, grading machines 107, and/or other machines of the system 100 configured to control various functions and/or features of the system 100. As used herein, the term “controller” is meant in its broadest sense to include one or more controllers, processors, central processing units, and/or microprocessors that may be associated with the system 100, and that may cooperate in controlling various functions and operations of the machines included in the system 100. The functionality of the system controller 122 may be implemented in hardware and/or software without regard to the functionality. The system controller 122 may rely on one or more data maps, look-up tables, neural networks, algorithms, machine learning algorithms, and/or other components relating to the operating conditions and the operating environment of the system 100 that may be stored in the memory of the system controller 122. The data maps noted above may include a collection of data in the form of tables, graphs, and/or equations to maximize the performance and efficiency of the system 100 and its operation.

The components of the control system 120 may be in communication with and/or otherwise operably connected to any of the components of the system 100 via a network 124. The network 124 may be a local area network (“LAN”), a larger network such as a wide area network (“WAN”), or a collection of networks, such as the Internet. Protocols for network communication, such as transmission control protocol/Internet protocol (TCP/IP), may be used to implement the network 124. Although examples are described herein as using a network 124 such as the Internet, other distribution techniques may be implemented that transmit information via memory cards, flash memory, or other portable memory devices.

It is also understood that the digging machines 102, loading machines 104, hauling machines 106, compacting machine 105, grading machine 107, and/or other machines of the system 100 may include respective controllers, and the respective controllers described herein (including the system controller 122) may be in communication and/or may otherwise be operably connected via the network 124. For example, the network 124 may comprise a component of a wireless communication system of the system 100, and as part of such a wireless communication system, the digging machines 102, loading machines 104, hauling machines 106, compacting machines 105, grading machines 107, and/or other machines of the system 100 may include respective communication devices 126. Such communication devices 126 may be configured to permit wireless transmission of a plurality of signals, instructions, and/or information between the system controller 122 and the respective controllers of the digging machines 102, loading machines 104, hauling machines 106, compacting machines 105, grading machines 107, and/or other machines of the system 100. Such communication devices 126 may also be configured to permit communication with other machines and systems remote from the worksite 112. For example, such communication devices 126 may include a transmitter configured to transmit signals (e.g., via the central station 108 and over the network 124) to a receiver of one or more other such communication devices 126. In such examples, the communication devices 126 may also include a receiver configured to receive such signals (e.g., via the central station 108 and over the network 124). In some examples, the transmitter and the receiver of a particular communication device 126 may be combined as a transceiver or other such component.

In any of the examples described herein, such communication devices 126 may also enable communication (e.g., via the central station 108 and over the network 124) with one or more tablets, computers, cellular/wireless telephones, personal digital assistants, mobile devices, or other electronic devices 128 located at the worksite 112 and/or remote from the worksite 112. Such electronic devices 128 may comprise, for example, mobile phones and/or tablets of project managers (e.g., foremen) overseeing operations at the worksite 112 or at a non-line-of-sight (NLOS) location with respect to the worksite 112. As used herein and in the appended claims, the term “non-line-of-sight (NLOS)” is meant to be understood broadly as any location with respect to the worksite 112 that is obstructed by a physical object such that electromagnetic waves cannot propagate between the location and the worksite 112.

The network 124, communication devices 126, and/or other components of the wireless communication system described above may implement or utilize any system or protocol including any of a plurality of communications standards. The protocols will permit communication between the system controller 122, one or more of the communication devices 126, and/or any other machines or components of the system 100. Examples of wireless communications systems or protocols that may be used by the system 100 described herein include a wireless personal area network such as Bluetooth RTM. (e.g., Institute of Electrical and Electronics Engineers (IEEE) 802.15), a local area network such as IEEE 802.11b or 802.11g, a cellular network, or any other system or protocol for data transfer. Other wireless communication systems and configurations are contemplated. In some instances, wireless communications may be transmitted and received directly between the control system 120 and a machine (e.g., the digging machines 102, loading machines 104, hauling machines 106, compacting machines 105, grading machines 107, among other machines described herein) of the system 100 or between such machines. In other instances, the communications may be automatically routed without the need for re-transmission by remote personnel.

In some examples, one or more machines of the system 100 (e.g., the digging machines 102, loading machines 104, hauling machines 106, compacting machines 105, grading machines 107, among other machines described herein) may include a location sensor 130 configured to determine a location, speed, heading, and/or orientation of the respective machine. In such examples, the communication device 126 of the respective machine may be configured to generate and/or transmit signals indicative of such determined locations, speeds, headings, orientations, haul distances, and/or area covered, to, for example, the system controller 122 and/or to the other respective machines of the system 100. In some examples, the location sensors 130 of the respective machines may include and/or comprise a component of global navigation satellite system (GNSS) or a global positioning system (GPS). Alternatively, universal total stations (UTS) may be utilized to locate respective positions of the machines. In some examples, one or more of the location sensors 130 described herein may comprise a GPS receiver, transmitter, transceiver, laser prisms, and/or other such device, and the location sensor 130 may be in communication with one or more GPS satellites 132 and/or UTS to determine a respective location of the machine to which the location sensor 130 is connected continuously, substantially continuously, or at various time intervals. One or more additional machines of the system 100 may also be in communication with the one or more GPS satellites 132 and/or UTS, and such GPS satellites 132 and/or UTS may also be configured to determine respective locations of such additional machines. In any of the examples described herein, machine locations, speeds, headings, orientations, and/or other parameters determined by the respective location sensors 130 may be used by the system controller 122 and/or other components of the system 100 to coordinate activities of the digging machines 102, loading machines 104, hauling machines 106, compacting machines 105, grading machines 107, and/or other components of the system 100.

The GPS satellites 132 and/or UTS may be used to receive machine data from the digging machines 102, loading machines 104, hauling machines 106, compacting machines 105, grading machines 107, and/or other machines of the system 100. Further, the GPS satellites 132 and/or UTS may be used to transmit that machine data to the system controller 122 or other data processing device or system within the system 100. The machine data may include production metrics from the digging machines 102, loading machines 104, hauling machines 106, compacting machines 105, grading machines 107, and/or other machines performing tasks within the worksite 112 of the system 100 and according to the worksite plan provided by, for example, the system controller 122 or another source.

The machine data may be machine telematics data that includes, for example, a location of the machines, utilization data that defines the manner, location, duration, and functions used by the machines, specifications of the machines, the health of the machines, and other telematics data. Telematics, as used herein, means the measuring, transmitting, and receiving of data defining a value of a quantity at a distance, by electrical translating means such as a wired or wireless communication network including the network 124. Further, in one example, the telematics data may also include a unique identifier for the machines 102, 104, 105, 106, 107. In one example, the telematics data may include data representing levels of completion of tasks assigned to the machines within the worksite plan or whether the tasks have been completed altogether. The telematics data may be represented using amounts of material 118 such as soil that is interacted with by the machines 102, 104, 105, 106, 107, an elevation of the work surface 110 of the worksite 112 as the material 118 is added to the worksite 112, and signals from the machines or users of the machines indicating completion of a task, among other representations within the telematics data.

For example, the digging machines 102 may reduce the material 118 for the purpose of loading the soil into, for example, the hauling machines 106 by the loading machines 104 for removal from or conveyance to the worksite 112. In so doing, respective sensors 130, controllers 136, and communication devices 126 associated with the machines 102, 104, 105, 106, 107 may sense, measure, process, and transmit data representing the completion of an instance of the reduction, loading and hauling of the material 118, the amount of material 118 the digging machines 102 reduce in volume (e.g., cubic meters (m³)) or mass (e.g., metric tons (t)), the area of the worksite 112 covered by the digging machines 102, and an elevation or “lift height” of the work surface 110 of the worksite 112, among other machine telematic data to, for example, the system controller 122. Further, the machine data may include any data defining the operation of the machines 102, 104, 105, 106, 107. For example, the machine data may include data such as: distances traveled; area of the worksite covered or moved over; volume, mass or weight extracted, hauled and/or deposited; duration of operation of the machines; fuel utilized by the machines; sensory information obtained from sensors within the machines, unique identifiers for the machines, a type of the machines, and location related parameters such as, region, district, and area; among other machine data.

Similarly, the loading machines 104 load material such as the material 118 into the hauling machines 106. The respective sensors 130, controllers 136, and communication devices 126 associated with the machines 102, 104, 105, 106, 107 sense, measure, process, and transmit the machine telematic data. The machine telematics data may include data representing the completion of an instance of the loading and hauling of the material 118, and the amount of the material in area (e.g., cubic meters (m³)) or mass (e.g., metric tons (t)), among other machine telematic data. In this manner, the sensors 130, controllers 136, and communication devices 126 may report the machine telematic data to the system controller 122.

In one example, the machine telematics data may be transmitted to the system controller 122 via wireless communication protocols provided by the central station 108, the satellite 132, and the network 124 to the system controller 122. In one example, a digital interface may be included with the machines 102, 104, 105, 106, 107 and/or the system controller 122 that may be used to indicate that the data transfer of the machine telematics data has occurred.

In one example, the sensor 130 may include a load cell configured to convert a force such as tension, compression, pressure, or torque into an electrical signal that can be measured and transmitted to, for example, the controllers 136, communication devices 126, and system controller 122. In another example, the sensor 130 may include a location sensor 130 that may track the position of the machines 102, 104, 105, 106, 107, and report that location data to the system controller 122 via the controllers 136 and communication devices 126 in order assume that the position of the machines 102, 104, 105, 106, 107 indicates a completion of one or more tasks. Further, the completion of an instance of the loading and hauling of the material 118 and the amount of the material in area (e.g., m³) or mass (e.g., t) moved by the hauling machines 106 as well as distances traveled by the hauling machines 106 in transporting the material, among other machine telematic data may be sensed, measured, processed, and transmitted to the system controller 122 using the sensors 130, controllers 136, and communication devices 126 associated with the machines 102, 104, 105, 106, 107.

As to the compacting machines 105, a completion of an instance of the compaction of the material 118, a portion in, for example, square meters (m²) of the work surface 110 of the worksite 112 over which the compacting machines 105 move over, and lift height of the work surface 110 of the worksite 112, among other machine telematic data may be reported to the system controller 122 using the sensors 130, controllers 136, and communication devices 126 associated with the compacting machines 105. In one example, the location sensor 130 may be used to determine the portion of the work surface 110 of the worksite 112 over which the compacting machines 105 move. In this example, the controllers 136 may calculate and/or otherwise determine the m² of the work surface 110 moved over by the compacting machines 105 and the communication devices 126 may telematically send data representing that measurement to the system controller 122. The system controller 122 may then determine that when a threshold or other predetermined amount of the work surface 110 has been covered, the task assigned to the compacting machines 105 has been completed. Further, an amount of material moved in area (e.g., m³) or mass (e.g., t), and square meters (m²) of the work surface 110 of the worksite 112 over which the grading machine 107 moves over, among other machine telematic data may be sensed, measured, processed, and transmitted by the sensors 130, controllers 136, and communication devices 126 associated with the grading machine 107 to the system controller 122.

Further, in an example, telematics data may include parameters related to operation of the associated machines 102, 104, 105, 106, 107 such as, for example, speed, heading direction, location of the machine 102, 104, 105, 106, 107, or any other telematic sensory information associated with the machine 102, 104, 105, 106, 107.

Thus, as described above, the machines 102, 104, 105, 106, 107 may report production metrics of different types including using wireless communications provided through the network 124. Thus, the metrics may be reported using the central stations 108, the GPS satellites 132 and/or UTS, or other communications devices and associated communication protocols. Users may measure truck loads delivered by the machines 102, 104, 105, 106, 107 and/or a final grade (e.g., via grade control, manual survey, or drone flight) of the worksite 112 to measure progress of the worksite plan such as a mass excavation project that utilizes a plurality of different machines 102, 104, 105, 106, 107. These two data points (i.e., truck loads and final grade of the worksite 112) may not provide insight into the worksite plan such as a mass excavation to pinpoint the underperforming machines 102, 104, 105, 106, 107 within the worksite plan. Other progress measurements may be used for the individual tasks within the worksite plan, but they are difficult to correlate to the upstream or downstream tasks or steps within the worksite plan. The different production metrics for the different machines 102, 104, 105, 106, 107 described herein may make it difficult in reporting an overall completion level of the worksite plan in which the machines complete a plurality of different tasks. Further, because the different machines 102., 104, 105, 106, 107 report different production metrics, it may be difficult to obtain insight into which machines within the worksite are underperforming within the overall worksite plan as described above. This is because it may be difficult to practically compare differing production metrics since they are thought to be incomparable or incommensurable metrics. These production metrics may be presented on a user interface such as those provided by the display devices of the electronic devices 128 within the system 100. Even with the display of these production metrics, a user, such as a supervisor, manager, crew member or other individual associated with the worksite plan, may find it difficult to understand the individual production metrics as it relates to other production metrics of the machines or within the overall worksite plan.

As discussed above, while resolving performance issues encountered in remotely managing a given construction assignment, a construction control authority may avoid the problem of manual intervention by remotely monitoring performance of each individual set of equipment to meet the construction assignment completion deadline. The construction assignment is divided into several lifts, wherein the completion of one lift may comprise several distinct sets of equipment completing their respective subtasks at a remote location. In other words, a lift may not be considered complete until each set of equipment of the multiple sets of equipment completes the individual task assigned to that set of equipment, since multiple sets of equipment may be involved in completing one lift. In one example, the worksite plan and any of the tasks associated with the worksite plan may be dictated by specifications and/or government regulations defining a maximum lift height that may be put in place and compacted before another lift may be placed on top of the previous lift. Thus, the worksite plan may be designed and completed with compliance to the specification and/or government regulations to avoid validation failure by, for example, an inspector of the worksite.

In the examples described herein, the machines 102, 104, 105, 106, 107 may report a unifying production metric referred to herein as a “lift count,” or machine data that is used to create the lift count metric. A lift count may be defined by and include at least one “lift” comprising an instance of completion of a material delivery task, a material spreading task, and a material compacting task by the machines 102, 104, 105, 106, 107, and each time these three tasks have been completed and additional lift count is enumerated. More details regarding the determination of a lift and enumeration of lift counts is provided herein. The data transmitted from the machines 102, 104, 105, 106, 107 may be processed by, for example, the system controller 122 using on one or more data maps, look-up tables, neural networks, algorithms, machine learning algorithms, and/or other components to obtain the lift count. In one example, the lift count may be processed using Equation 1 described below or other similar algorithms, and stored in a memory of the system controller 122 within, for example, a look-up table or other data array for data retrieval purposes. The lift count is directly comparable between machines 102, 104, 105, 106, 107 despite the differences in tasks that are performed by the individual machines and their respective, individual production metrics. This lift count as a metric may be used to measure an overall progress of the worksite plan progress as well as the efficiency of the system 100 and the efficiency of individual machines 102, 104, 105, 106, 107 as they operate to complete tasks within the worksite plan.

Further, in one example, the system controller 122 of the system 100 may track progress using the lift count metric without a knowledge of the overall worksite plan. In this example, an indication that a material delivery task, a material spreading task, and a material compacting task has been completed by the machines 102, 104, 105, 106, 107 may be reported to the system controller 122. The material delivery task, the material spreading task, and the material compacting task may be identified by the system controller 122 as being equivalent to a lift count and the number of lift counts may be enumerated without knowing a total goal of, for example, 300 lift counts. A representation of this tracked number of lift counts may be presented to a user on display devices of the electronic devices 128, for example. Further, the system controller 122 of the system 100 may report to a user a per-task progress of the individual machines 102, 104, 105, 106, 107. For example, the system controller 122 may report that 12 tasks have been completed by a loading machine 104, and that 8 tasks have been compacted by a compacting machine 105. The presentation of per-machine production metrics to a user allows the user to understand how efficiently the machines 102, 104, 105, 106, 107 are performing.

In one example, the lift count metric may be calculated and/or otherwise determined by the system controller 122 as machine data is received from the machines 102, 104, 105, 106, 107. The machine data may either be requested by the system controller 122 or passively received by the system controller 122 as the machines 102, 104, 105, 106, 107 constantly or periodically transmit the machine data. In one example, the machines 102, 104, 105, 106, 107 transmit machine data via the respective communication devices 126 of the machines, through the central station 108 and the network 124 to the system controller 122.

In one example, the unifying production metric may be calculated and/or otherwise determined based at least partially on data input by a user at an initial creation of the worksite plan, machine data as received from the machines 102, 104, 105, 106, 107, dimensions of the machines, and combinations thereof. The data input by the user may include data associated with, for example, the material 118 that is being interacted with on the worksite 112 including, for example, the identification of the material 118 (including but not limited to soil, coal, sand, stone and the like), characteristics or properties of the material such as density (kg/m3), load factors (i.e., % of rated capacity to expect per load), coarseness, fineness, moistness, brittleness and the like, identification of a task to be performed with the material 118 (including but not limited to digging, compacting, moving and the like), tag assignment within a wireframe, desired task termination criteria (for example for a compacting machine an intended level of compaction), a lift height defined as an intended elevation of the work surface 110 of the worksite 112, a target or goal timeline to complete a number of tasks within the worksite plan and/or the overall worksite plan, a total area of the work surface 110 and/or the worksite 112, and a haul distance defined by the distance a hauling machine 106, for example, moves material to and/or from the worksite 112, among other user inputs.

The machine dimensions may be used in calculating the lift count and may include any dimension of the machines 102, 104, 105, 106, 107 such as, for example, a blade width of a loading machine 104 or a grading machine 107, a drum width of, for example, a compacting machine 105, a volume of a dump bed of, for example, a hauling machine 106, and a volume of a bucket of, for example, a digging machine 102, among other dimensions of the machines. Further, in one example, location data determined by the location sensor 130 for the machines 102, 104, 105, 106, 107 may be sent via the communication devices 126, the central station 108, and the network 124 to the system controller 122 in order to include this data as part of the machine dimensions. Further, in one example, the machine dimensions may be used by the system controller 122 to create and estimate the lift count. In this example, sensors 130 that are able to detect an amount of material within a hauling machine 106, within a work tool 140 (e.g., buckets and blades) of a digging machine 102, a loading machine 104, and/or a grading machine 107 may be used to determine whether a task associated with the movement of material 118 has been completed. The sensors 130 may detect the amount of material, and report this amount to the system controller 122 via the communication devices 126, the central station 108, and the network 124 for processing by the system controller 122.

The machine data may be received from the machines 102, 104, 105, 106, 107 by the system controller 122. Specifically, the machines 102, 104, 105, 106, 107 may send the machine data to the system controller 122 via the communication devices 126, the central station 108, and the network 124.

The lift count metric includes an estimate of “area at lift.” In one example, the area at lift may be defined as a compacted volume of a material per hauling unit. In this example, the volume may be measured in cubic meters (m³). The hauling machines 106 may be identified and used as the hauling units. In one example, volume may be determined based on shrink and swell properties of the material such as the material 118 which may swell in the presence of fluids such as water and shrink or retract as the fluid leaves the material 118. In one example, sensors 130 may detect the degree to which the material 118 settles within a bed of a hauling machine 106. The shrink and swell properties of the material may vary throughout the tasks of the worksite plan in which different machines 102, 104, 105, 106, 107 interact with the material such as the material 118. Because shrink and swell of the material 118 may change at the instances of interaction between the machines 102, 104, 105, 106, 107 and the material 118, estimating the intermediate volume of the material 118 may prove difficult. Therefore, the present system 100 may measure compacted volumes where the volume of the soil 118 or other material is measured in place after it is compacted on the worksite 112. Thus, measurement of any intermediate, non-compacted, loose material 118 may not be made in order to remove inaccurate measurements from the present systems and processes.

In another example, the area at lift may be defined as a lift height including a depth of the material such as the soil 118 as compacted along a surface of the worksite 112. In this example, the elevation of the work surface may be measured as the lift height and may be defined as a depth of material such as the soil 118 that has been spread and compacted to an intended level of compaction at the worksite 112. In one example, after compaction the lift height may be measured, and another amount of material forming a next layer on the work surface 110 of the worksite 112 may be added. Accordingly, multiple lifts may be used to transform the initial work surface to the final work surface.

In yet another example, the area at lift may be a combination of the above two examples where the area at lift (defined as the compacted volume of the material per hauling unit) and the lift height are considered in calculating the area at lift as the lift count. In this example, both the volume of the material 118 as compacted at the work surface 110 of the worksite 112 and the elevation of the work surface 110 of the worksite 112 may be measured to obtain the lift count. In this example, the lift count obtained from each of the volume of the material 118 as compacted at the work surface 110 and the elevation of the work surface 110 may be individually calculated and an average, mean, median, and/or mode of the two may indicate the area at lift. Thus, an estimate of how much compacted area at the specified lift being hauled per truck can be calculated and/or otherwise determined by considering: lift height, truck size (or payload), and the material properties.

In practice, the area at lift may be realized as material is added to the work surface 110 of the worksite 112 by a combination of digging machines 102, loading machines 104, and hauling machines 106 move the material to the worksite. The hauling machines 106 and grading machines 107 may spread the material along the work surface 110 of the worksite 112. The compacting machines 105 may then compact the material to an intended density. This process of material delivery, spreading, and compaction may be equivalent to one “lift,” and the unifying production metric may be measured after the lifts. In another example, the system controller 122 may calculate and report a volume of material per task. For example, it may be reported that 120,000 yd³ of the material has been loaded and hauled to the worksite by the digging machines 102, loading machines 104, and hauling machines 106, and that 80,000 yd³ of the material has been compacted using the grading machines 107 and the compacting machines 105.

In one example, the estimate of the lift count may also be determined by considering truck loads or payloads produced by the digging machines 102, loading machines 104, and hauling machines 106 as the metric applied to the work performed by the grading machines 107 and compacting machines 105. Thus, instead of basing the estimation of the completion of a number of tasks within the worksite plan or the worksite plan overall on the compacted volume of the material and the lift height, the lift count may be determined based on the amount in, for example, volume, mass, or weight of the material dug, loaded and hauled by the digging machines 102, loading machines 104, and hauling machines 106. This amount of material hauled may be applied to the operation of the grading machines 107 and the compacting machines 105 such that a level of completion of a task within the worksite plan or a level of completion of the worksite plan as a whole by the grading machines 107 and the compacting machines 105 may be based on the amount of material 118 hauled.

In the examples described herein, the unifying production metric or “area at lift” may be correlated to volumetric measures at the sub-processes or tasks within the overall worksite plan. In this example, a look-up table may be used by the system controller 122 to indicate what volumes of material correlate with what constitutes an area at lift. Further, in this example, the production metrics may be aggregated at three separate levels including the individual machine level where the individual machines 102, 104, 105, 106, 107 aggregates its production metrics, at a sub-system level, and at a jobsite level where production metrics from the machines 102, 104, 105, 106, 107, are aggregated. Here, the sub-system level may include any machine 102, 104, 105, 106, 107 or groups of machines within the system, and the jobsite level includes the machines 102, 104, 105, 106, 107 together. Advantageously, aggregating production metrics together into a data set may improve processing time and reduce an amount of data transmitted between the machines 102, 104, 105, 106, 107 and the system controller 122. Thus, aggregation of the production metrics results in a more effective and efficient use of computing resources within the overall system 100.

As to the sub-system level of production metric aggregation, in one example, like production metrics may be collected by the system controller 122 and/or reported by the similar machines 102, 104, 105, 106, 107 that perform a common task and/or operation. In these examples, a plurality of the loading machines 104, for example, may share a common task and/or operation, and the machine data reported by the loading machines 104 may be aggregated together as a production metric. For example, six separate loading machines 104 working together in a hauling task may deliver 100,000 yd³ of material 118. As the individual loading machines 104 contributed unequally to the total amount, the aggregated amount of material may be reported.

Further, machines 102, 104, 105, 106, 107 that perform the same task may also collectively report production metrics aggregated together as a production metric. For example, the digging machines 102, loading machines 104, and hauling machines 106 may participate in the same task of material delivery to the worksite 112. Further, in this example, the grading machines 107 may participate in the spreading of the material 118 within the worksite. The grading machines 107 and the compacting machines 105 may participate in the compacting of the material 118 within an area of the worksite 112. Thus, in this example, three different tasks within a lift may include a material delivery task, a material spreading task, and a material compacting task where the completion of these three tasks is equivalent to a lift count and is enumerated as such.

The machines 102, 104, 105, 106, 107 that may report identical production metrics may also collectively report production metrics aggregated together as a production metric even in situations where the machines 102, 104, 105, 106, 107 may perform different tasks. In this example, production metrics for a digging machine 102 and a loading machine 104 may be aggregated together either before or after sending the telematics data to the system controller 122 since the production metric for the digging machine 102 and a loading machine 104 may be a measure of volume or mass of material moved by their respective work tools 140 (e.g., buckets) irrespective of the dimensions of the work tools 140.

In any of the examples described herein, the system controller 122 may be configured to generate a user interface (UI) (not shown) that includes, among other things, information indicative of the level or percentage of completion of tasks within the worksite plan and/or a level or percentage of completion of the worksite plan as a whole. Further, in one example, the UI may display the lift count as a metric and/or other metrics in a graphical manner. The UI may depict the production metrics in the form of a red. yellow and green chart where red hues indicate a relatively lower percentage of completion of the tasks and/or the overall worksite plan relative to yellow hues, and yellow hues indicate a relatively lower percentage of completion of the tasks and/or the overall worksite plan relative to green hues. Other forms and methods of graphically depicting a level of completion of the tasks and/or the overall worksite plan are contemplated herein. Overall, the UI allows a user to easily understand the how the tasks and/or the overall worksite plan is moving along. In one example, the UI may be presented to a user and rendered interactive such that the user may select portions within the UI to drill down to levels within the worksite plan to determine efficiency within tasks and identify specific groups of machines 102, 104, 105, 106, 107 or individual machines that are or are not working as efficiently as expected or intended.

In any of the examples described herein, such UIs may be generated and provided by the controller 136 within the machines 102, 104, 105, 106, 107 to, for example, the electronic device 128 (e.g., via the network 124), a display of the machines 102, 104, 105, 106, 107, the system controller 122 (e.g., via the network 124), and/or to one or more components of the system 100 for display. Additionally or alternatively, such user interfaces may be generated and provided by the system controller 122 to, for example, the electronic device 128 (e.g., via the network 124), a display of the machines 102, 104, 105, 106, 107, and/or to one or more components of the system 100 for display.

In any of the examples described herein, one or more of the digging machines 102, loading machines 104, hauling machines 106, compacting machines 105, grading machine 107, and/or other machines of the system 100 may be manually controlled, semi-autonomously controlled, and/or fully-autonomously controlled. In examples in which the digging machines 102, loading machines 104, hauling machines 106, compacting machines 105, grading machine 107, and/or other machines of the system 100 are operating under autonomous or semi-autonomous control, the speed, steering, work tool positioning/movement, and/or other functions of such machines may be controlled automatically or semi-automatically based at least in part on the determined travel parameters and/or work tool positions described herein.

With continued reference to FIG. 1, and as noted above, the digging machines 102, loading machines 104, hauling machines 106, compacting machines 105, grading machine 107, and/or other machines of the system 100 may include a controller 136 as described herein. The controller 136 may comprise a component of a local control system on-board and/or otherwise carried by the respective machine 102, 104, 105, 106, 107. The controllers 136 may be any embedded system within the machines 102, 104, 105, 106, 107 that controls at least one of the electrical systems or subsystems in the machines 102, 104, 105, 106, 107, and thus at least one function of the machines 102, 104, 105, 106, 107. Such controllers 136 may be generally similar or identical to the system controller 122 of the control system 120. For example, such controllers 136 may comprise one or more processors, a memory, and/or other components described herein with respect to the system controller 122. The controllers 136 may include an electronic control unit (ECU) such as, for example, an electronic control module (ECM), a powertrain control module (PCM), a transmission control module (TCM), an electronic brake control module (EBCM), a central control module (CCM), a central timing module (CTM), a general electronic module (GEM), a body control module (BCM), a suspension control module (SCM), and a control unit, among other types of ECUs. The ECUs may include hardware and embedded software that assist in the operation of the machines 102, 104, 105, 106, 107.

In some examples, a controller 136 may be located on a respective one of the machines 102, 104, 105, 106, 107, and may also include components located remotely from the respective one of the machines 102, 104, 105, 106, 107, such as on any of the other machines of the system 100 or at the command center described herein (not shown). Thus, in some examples the functionality of the controller 136 may be distributed so that certain functions are performed on the respective one of the machines 102, 104, 105, 106, 107 and other functions are performed remotely. In some examples, controller 136 of the local control system carried by a respective machine 102, 104, 105, 106, 107 may enable autonomous and/or semi-autonomous control of the respective machine either alone or in combination with the control system 120. Further, the controller 136 carried by a respective machine 102, 104, 105, 106, 107 may instruct the respective communication devices 126 and location sensors 130 to function as described herein and as directed by, for example, the system controller 122.

With continued reference to FIG. 1, in some examples one or more machines 102, 104, 105, 106, 107 of the system 100 may include an implement or other work tool 140 that is coupled to a frame of the machine. For example, in the case of a loading machine 104, the work tool may comprise a bucket configured to carry material within an open volume or other open space thereof. The loading machine 104 may be configured to, for example, scoop, lift, and/or otherwise load material (e.g., material removed by the digging machines 102) into the work tool 140 by lowering the work tool 140 to a loading position. For example, the loading machine 104 may include one or more linkages 142 movably connected to a frame of the loading machine. The work tool 140 may be connected to such linkages 142, and the linkages 142 may be used to lower the work tool 140 (e.g., via one or more hydraulic cylinders, electronic motors, or other devices connected thereto) to a loading position in which a leading edge 144 of the work tool 140 is disposed proximate, adjacent, and/or at the work surface 110, and a base of the work tool 140 is disposed substantially parallel to the work surface 110. The loading machine 104 may then be controlled to advance along the surface of the work surface 110 of the worksite 112 such that the work tool 140 may impact the material, a positive-volume of material 118, and/or other object disposed on the work surface 110 so as to transfer the material at least partially into the open space of the work tool 140. The linkages 142 may then be controlled to raise, pivot, and/or tilt the work tool 140 to a carrying position above the work surface 110. The loading machine 104 may then be controlled to traverse the worksite 112 until the loading machine 104 reaches a dump zone, the hauling machine 106, and/or another location at the worksite 112 designated for receiving the removed material being carried by the work tool 140. The linkages 142 may then be controlled to lower, pivot, and/or tilt the work tool 140 to an unloading position in which the material carried within the open space of the work tool 140 may be deposited (e.g., due to the force of gravity acting on the material carried by the work tool 140) at the dump zone, within a bed of the hauling machine 106, and/or as otherwise intended. Like the loading machines 104, the digging machines 102, hauling machines 106, compacting machines 105, grading machine 107, may also include work tools 140 and/or linkages 142 that allow the machines to perform their respective operations as described herein.

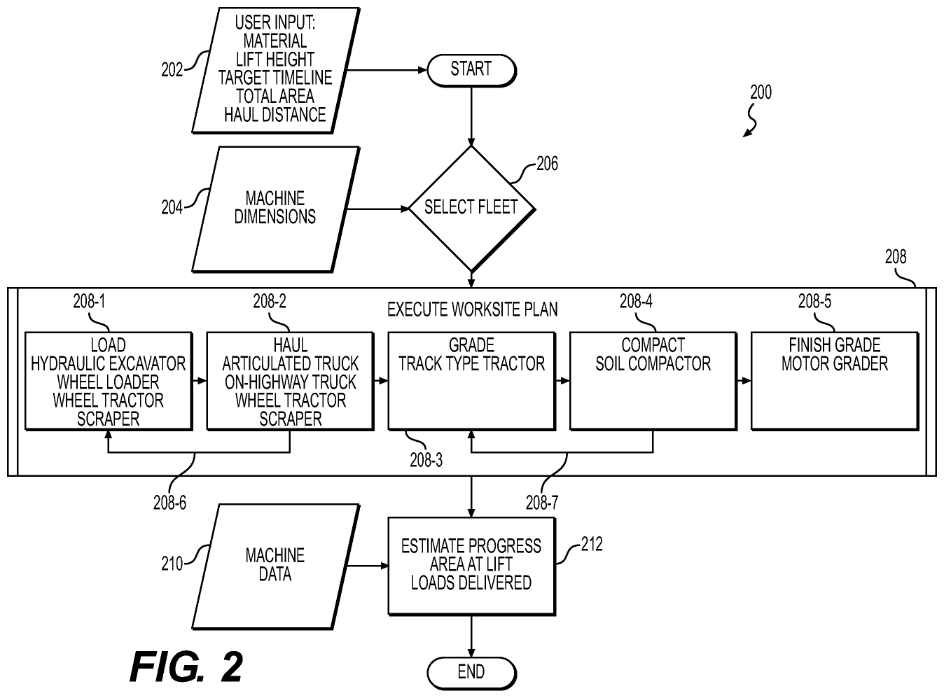

FIG. 2 is a flow chart depicting an example method 200 associated with the system 100 shown in FIG. 1. The example method 200 is illustrated as a collection of steps in a logical flow diagram, which represents operations that can be implemented in hardware, software, or a combination thereof. In the context of software, the steps represent computer-executable instructions stored in memory. When such instructions are executed by, for example, the system controller 122 of the control system 120, such instructions may cause the machines 102, 104, 105, 106, 107, various components of the control system 120 (e.g., the electronic devices 128), a controller of a digging machine 102, a controller of a loading machine 104, a controller of a hauling machine 106, a controller of a compacting machine 105, a controller of a grading machine 107, and/or other components of the system 100 to perform the recited operations. Such computer-executable instructions may include routines, programs, objects, components, data structures, and the like that perform particular functions or implement particular abstract data types. The order in which the operations are described is not intended to be construed as a limitation, and any number of the described steps can be combined in any order and/or in parallel to implement the process. For discussion purposes, and unless otherwise specified, the method 200 and other methods described herein is described with reference to the system 100, the control system 120, the controllers 136 of the machines 102, 104, 105, 106, 107, the worksite 112, and/or other items shown in FIG. 1. In particular, although any part of and/or the entire method 200 may be performed by the system controller 122, the electronic devices 128, a controller 136 of the machines 102, 104, 105, 106, 107, and/or other components of the system 100, either alone or in combination, unless otherwise specified, the method 200 will be described below with respect to the system controller 122 for ease of description.

With reference to FIG. 2, at 202 the system controller 122 may receive information associated with one or more tasks, jobs, or other operations to be performed by the system 100 at the worksite 112. The information received at 202 may include, for example, among other things, user inputs 202 that define a worksite plan that is to be executed by one or more of the machines 102, 104, 105, 106, 107 of the system 100 at the worksite 112. A worksite plan may include, for example, instructions, locations (e.g., GPS coordinates, UTS coordinates, etc.), and/or other information identifying a perimeter and/or boundary of at least a portion of the work surface 110 within which such operations are to be performed.

The user inputs 202 may also include characteristics of materials within the worksite 112. For example, the materials may include the soil 118, sand, minerals, gravel, stones, rocks, boulders, concrete, asphalt, and overburden, among other materials.

Further, the user inputs 202 may include a target timeline, deadline or goal. In one example, the target timeline, deadline or goal may be associated with a number of individual tasks within the worksite plan. In one example, the target timeline, deadline or goal may be associated with the worksite plan overall that defines a completion of the worksite plan and the number of tasks within the worksite plan.

The user inputs 202 may also include haul distances within the worksite and between off-site locations and the worksite 112. The user input may further include details regarding the worksite plan such as, for example, GPS coordinates identifying a boundary and/or other area of the work surface 110, an intended lift height, elevation grade and other characteristics of the work surface 110 of the worksite 112 to be achieved by the worksite plan, and current elevations along the work surface 110 of the worksite 112, among other data relating to the worksite 112. In some examples, the worksite plan may include a first set of GPS coordinates, and/or other information identifying locations of the material, and a second set of GPS coordinates identifying a dump zone, a working zone where one or more of the machines 102, 104, 105, 106, 107 are assigned to or are currently working, and/or other areas within the worksite 112 where work may be performed.

In some examples, the user input including the worksite plan received at 202 may also include information indicative of the type of material to be moved (e.g., soil, sand, minerals, gravel, concrete, asphalt, overburden, etc.), information uniquely identifying the machines 102, 104, 105, 106, 107 present at the worksite 112 (e.g., one or more license plate numbers, model numbers, machine types, and/or other unique identifiers associated with the respective machines of the system 100 present at the worksite 112), information uniquely identifying the operators of the respective machines (e.g., names, employers, employee identification numbers, experience levels, and/or other information), a two-dimensional and/or three-dimensional map of the worksite 112, GPS coordinates of any known imperfections or other obstacles at the worksite 112 (e.g., GPS coordinates identifying the location, boundary, and/or extent of one or more trees, bodies of water, man-made obstruction, power lines, utility lines, drainage lines, roads, sidewalks, parking lots, etc.), and/or other information associated with the system 100 and/or the worksite 112.

At 204, the system controller 122 may receive machine dimensions from the machines 102, 104, 105, 106, 107 present at the worksite 112. As described herein, the machine dimensions may include any dimension of the machines 102, 104, 105, 106, 107 such as, for example, a blade width of a loading machine 104 or a grading machine 107, a drum width of, for example, a compacting machine 105, a volume of a dump bed of, for example, a hauling machine 106, and a volume of a bucket of, for example, a digging machine 102 or a loading machine 104, among other dimensions of the machines. In one example, the machine dimensions received at 204 may be received by the system controller 122 through user input to, for example, the system controller 122 itself or an electronic device 128. In another example, the machine dimensions may be obtained by the system controller from a database within the system controller 122 or any of the electronic devices 128. In this example, the database of the system controller 122 or the electronic device 128 may be accessed as the fleet of machines 102, 104, 105, 106, 107 is selected at 206 such that the dimensions of those machines 102, 104, 105, 106, 107 selected may be obtained from the database. Further, in one example, at 204 location data determined by the location sensor 130 for the machines 102, 104, 105, 106, 107 may be sent via the communication devices 126, the central station 108, and the network 124 to the system controller 122 in order to include this data as part of the machine dimensions. The machine dimensions may be used by the system controller 122 to create and estimate the unifying production metric. The unifying production metric may be used as data to support a depiction of a level of completion of tasks within a worksite plan or the worksite plan overall in a UI as described herein.

At 206, a fleet of machines is selected. In one example, the fleet is selected from the types of machines 102, 104, 105, 106, 107 described herein. The fleet may be autonomously selected by the system controller 122 based on the user inputs and worksite plan obtained at 202 and/or 204. In this example, the types of work performed as defined within the worksite plan and the tasks defined in the worksite plan may be used to select which of the machines 102, 104, 105, 106, 107 will participate in performing the tasks within the worksite plan. In another example, the fleet may be selected by a number of users such as a supervisor, manager, crew member or other individual associated with the worksite plan. In this example, the system controller 122 may prompt one or more of these individuals to provide such input to the system controller 122. Further, in one example, the fleet may be selected in order to obtain at least two different types of machines 102, 104, 105, 106, 107 that may complete tasks within a lift and in order to enumerate a lift count upon completion of the at least two tasks.

Once the fleet of machines 102, 104, 105, 106, 107 has been selected, the system controller 122 executes 208 the worksite plan by sending instructions to the machines 102, 104, 105, 106, 107 to perform their respective tasks. The execution of the worksite plan may include loading 208-1, hauling 208-2, grading 208-3, compacting 208-4, and finish grading 208-5 the material such as the soil 118 at the worksite 112. Loading 208-1 the material may include using an excavator, backhoe, dozer, drilling machine, trencher, drag line, a wheel loader, a wheel tractor, a tracked loader, a front shovel, a cable shovel, a stack reclaimer, a scraper, and/or other digging machines 102 and loading machines 104 to excavate and load material such as the soil 118 into a hauling machine 106. Hauling 208-2 the material may include using an articulated truck, an off-highway truck, an on-highway dump truck, and a wheel tractor scraper, among other types of hauling machines 106 to move the material to and from the worksite 112 or between separate locations within the worksite 112. As designated by arrow 208-6, the hauling machines 106 may return any number of times to the location of the loading machines 104 to load 208-1 and haul 208-2 more material. In the examples described herein, the material delivery task may include the actions taken by at least the loading 208-1 and hauling 208-2 operations within the execution 208 of the worksite plan. This material delivery task may be included as one of the plurality of tasks performed by the machines 102, 104, 105, 106, 107 that collectively form the lift count described herein.

The execution of the worksite plan may also include grading 208-3 the work surface 110 of the worksite 112. Grading 208-3 the work surface 110 may be performed using track-type tractors, scrapers, bulldozers, motor graders, and other grading machines. In the examples described herein, the material spreading task may include the actions taken by at least the grading 208-3 operations within the execution 208 of the worksite plan. This material spreading task may be included as one of the plurality of tasks performed by the machines 102, 104, 105, 106, 107 that collectively form the lift count described herein.

Further, the execution of the worksite plan may include compacting 208-4 the material such as the soil 118 using a double drum compacting machine, a wheeled or tracked soil compactor, a vibratory soil compactor, and a tandem vibratory compactor among other types of compacting machines 105. The grading 208-3 and compaction 208-4 may be performed in series a number of times as indicated by arrow 208-7 in order to maintain a graded surface as compaction 208-4 is performed. At 208-5, a finish grade may be obtained at the work surface 110 through the use of a scraper, bulldozer, motor grader, or other machine. The finish grade is performed to create a flat surface by grading material such as soil at the worksite 112 for subsequent operations such as, for example, additional compacting operations 208-4, or placement of paved surfaces or structures on the finished grade. In the examples described herein, the material compacting task may include the actions taken by at least the grading 208-3, the compaction 208-4, and the finish grading 208-5 operations within the execution 208 of the worksite plan. This material compacting task may be included as one of the plurality of tasks performed by the machines 102, 104, 105, 106, 107 that collectively form the lift count described herein.

In one example, the individual machines 102, 104, 105, 106, 107 may execute their respective tasks within the worksite plan independently. In this example, the machines 102, 104, 105, 106, 107 may continually or periodically send machine data representing production metrics including an indication of completion of tasks, and the system controller 122 of the system 100 may passively receive the production metrics from the machines to estimate the progress of the individual tasks and/or the overall worksite plan.

In one example, the processes performed by the machines 102, 104, 105, 106, 107 at 208 may be performed autonomously and/or semi-autonomously. In these autonomous and/or semi-autonomous scenarios, the system controller 122 may cause the machines 102, 104, 105, 106, 107 to perform their respective tasks as described herein by sending instructions to the respective controllers 136 of the machines 102, 104, 105, 106, 107 via the network 124, the satellite 132 and/or the central stations 108, and communication devices 126 of the respective machines 102, 104, 105, 106, 107. The controllers 136 of the machines 102, 104, 105, 106, 107 may execute the instructions as received from the system controller 122 to cause the machines 102, 104, 105, 106, 107 to perform the tasks as defined by the instructions.

At 210, a component of the system 100 may provide machine data to the system controller 122. At 212, the system controller 122 may estimate 212 progress with respect to the tasks defined by the worksite plan and/or the worksite plan overall. As described herein, the system controller 122 uses a lift count to determine the level or percentage of completion of the tasks defined by the worksite plan and/or the worksite plan overall. The lift count may be obtained from the machines 102, 104, 105, 106, 107 as the machine data 210 or may be calculated and/or otherwise determined or derived by the system controller 122 from the machine data 210. Also, as described herein, the lift count may be based on area at lift and number of loads delivered. In one example, the unifying production metric may be calculated or derived based on the following:

Lift=Mat_{Del}+Mat_{Sp}+Mat_{Com} Eq. 1

where: Mat_{Del} is the material delivered to the worksite 112; Mat_{Sp} is the material spread along the work surface 110 of the worksite; and Mat_{Com} is the material compacted along the work surface 110 of the worksite.

In Eq. 1, the lift may be determined irrespective of mass or volume of the material delivered, spread, and compacted since the masses and volumes may be inconsistently measured by, for example, the digging machines 102, loading machines 104, and hauling machines 106 (i.e., as material delivery machines), grading machines 107 (i.e., as material spreading machines), and the grading machines 107 and the compacting machines 105 (i.e., as material compacting machines). Thus, once the three types of machines 102, 104, 105, 106, 107 have worked a given area, one lift is considered complete, and a lift count may be enumerated. The unifying production metric may be described as area at lift and may be calculated or derived as follows:

$$Unifying Production Metric = \frac{Lift}{Area} \qquad Eq . 2$$

where the Area is the square meter (m²) value at which the lift was completed. In one example, the worksite 112 may be divided into segments such as the m² value, and the movement of the hauling machines, the spreading machines, and the compacting machines may be tracked based on location data obtained from the machines 102, 104, 105, 106, 107. In this example, the completion of the tasks may be based at least in part on the location data, and the lift count may include a measure of a lift height defined by a depth of a material deposited and compacted within the segmented portion of the worksite. Bulk earthmoving may include placement of material 118 in “lifts” as described herein. A lift may be defined as a vertical distance to be placed and compacted before additional material 118 from additional lifts may be placed thereon.

A lift, in addition to the description provided herein, may be defined as a total amount of material 118 placed and compacted to create a desired final work surface. A lift may be expressed as follows:

Volume=Number of lifts completed*Area worked*lift height Eq. 3

where the number of lifts completed is determined by the material delivered to a location, spread across the work surface 110 and compacted. The area worked is base on the latitude and longitude of the machines performing the work. The lift height is a nominal value entered by a user or site manager.

Thus, the present systems and methods may be used to measure production based on the lifts performed and completed and may include determining which of a number of lifts the machines 102, 104, 105, 106, 107 are currently working. In the case of grading machines 107 and compacting machines 105, this may be helpful since these types of machines may be working in relatively smaller geographical areas than other types of machines, but may have completed multiple “lifts.” In some situations, it may prove difficult to gauge how many lifts have been completed even using precision GPS data since the GPS data may have a margin of error as to an accurate elevation of the work surface 110 of the worksite 112. The present systems and methods provide for the combination of the telematics data from a plurality of the machines 102, 104, 105, 106, 107 to determine the number of lifts completed within the worksite plan.

To provide context for the above, in one example, data from multiple machines 102, 104, 105, 106, 107 may be combined to determine the number of lifts completed. For a lift to be considered complete, three tasks must take place as describe herein. First, material is delivered to the worksite 112. This may be accomplished via the digging machines 102, the loading machines 104, and the hauling machines 106. The dump locations may be close to where the material will be spread. Second, grading machines 107 may spread the material out at a depth specified by the worksite plan. Third, compacting machines 105 and grading machines 107 may compact the recently spread material 118 to bring that material 118 to the compaction level specified in the worksite plan. Compaction of the material may take a plurality of passes by the compacting machine 105. Thus, a “lift” may be defined as material delivery, spread, and compaction. The unifying production metric that provides for a common production metric between the machines 102, 104, 105, 106, 107 of different types and different individual production metrics may be defined based on the number of lifts performed within the specified area of the worksite 112. In this manner, a user may be able to more readily understand how differing production metrics from different machines 102, 104, 105, 106, 107 that otherwise may not be practically compared due to their incomparable or incommensurable metrics, may be understood using the unifying production metric described herein.

In one example, the system controller 122 may calculate or enumerate the lift count based on the completion of the tasks within the worksite plan. In its calculations, the system controller 122 may rely on one or more data maps, look-up tables, neural networks, algorithms, machine learning algorithms, and/or other components relating to the operating conditions and the operating environment of the system 100 that may be stored in the memory of the system controller 122.

In one example, the lift count metric may include a measure of an area within the segmented portion of the worksite 112 such as the work surface 110 of the worksite 112 at a particular lift height. The lift height may be defined by a depth of a material deposited and compacted within the segmented portion of the worksite 112. In one example, bulk earthmoving may include material placement in “lifts” as described above. A lift may be defined as a specified vertical distance to be placed and compacted before additional material (i.e., additional lifts) may be placed on top. To measure machine production, it may be helpful to determine how many lifts have been completed or which lift the machine 102, 104, 105, 106, 107 is currently performing the work. In this example, this process may apply to grading machines 107 and compacting machines 105 because these machines may be working in the same small geographical area within the worksite 112 but have completed multiple lifts.

The lift count metric described herein may alleviate any difficulties as to how to gauge how much of the worksite plan has been completed using traditional machine data. High precision GPS data obtained from the location sensors 130 may be utilized for accurate elevation data. Even with the use of GPS data from the location sensors 130, lift height may be within a margin of error. The lift count as derived and calculated by the system controller 122 provides a means for the progress of the equipment working in a given area and the worksite plan to be determined, and not just for those machines equipped with high precision GPS with grade control systems.

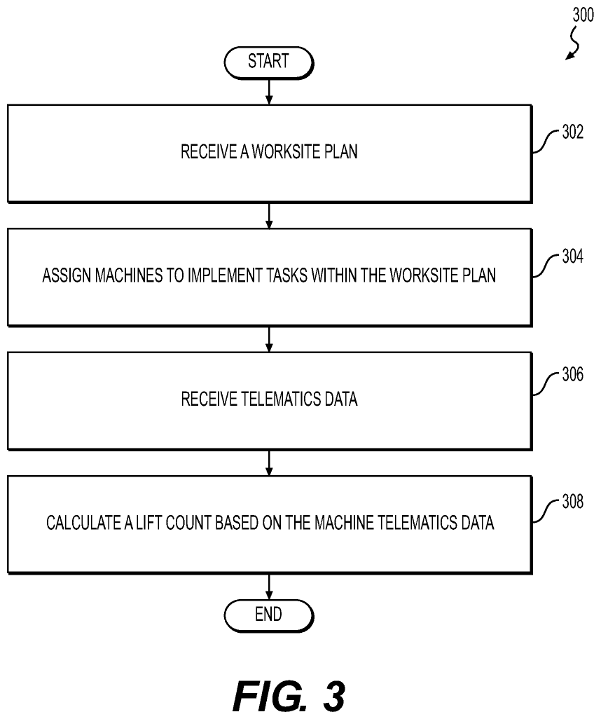

FIG. 3 is a flow chart depicting an example method 300 associated with the systems and methods shown in FIGS. 1 and 2. At 302, a controller, such as the processing and memory architecture of the system controller 122 of the control system 120, may receive a worksite plan to be executed by the machines 102, 104, 105, 106, 107 at a worksite. In one example, the worksite plan to be executed by a hauling machine, a spreading machine, and a compacting machine at a worksite 112 to complete a hauling task, a spreading task and a compacting task, respectively. The worksite plan includes any number of tasks to be performed by the machines 102, 104, 105, 106, 107 that brings about an intended change in a work surface 110 of the worksite 112. As described herein, the worksite plan may include a mass excavation project that utilizes a plurality of different machines 102, 104, 105, 106, 107. The worksite plan may include, for example, instructions, locations (e.g., GPS coordinates, UTS coordinates, etc.), and/or other information identifying a perimeter and/or boundary of at least a portion of the work surface 110 within which such operations or tasks are to be performed.

In one example, the worksite plan may be included as user input (e.g., FIG. 2, 202) and may be input to the electronic devices 128 located at the worksite 112 and/or remote from the worksite 112 or to the system controller 122 directly. In another example, the worksite plan may be generated by the system controller 122 or other processing device based on the user input (e.g., FIG. 2, 202).

At 304, the system controller 122 may assign the machines 102, 104, 105, 106, 107 to implement the tasks worksite plan. In one example, the hauling machines such as the digging machines 102, the loading machines 104, and the hauling machines 106 may be used to execute the tasks assigned to the hauling machines. Further, in this example, the grading machines 107 may be used to execute the tasks assigned to the spreading machines. The grading machines 107 and compacting machines 105 may be used to execute the tasks assigned to the compacting machines. In this manner, the machines 102, 104, 105, 106, 107 described herein may be assigned tasks based on their respective capabilities. The capabilities of the machines 102, 104, 105, 106, 107 are defined by what type of machines they are (e.g., digging machines 102, loading machines 104, hauling machines 106, compacting machines 105, grading machines 107, and/or other types of machines) and their associated functions. The machines selected (FIG. 2, 206) may be based at least partially on the tasks defined within the worksite plan.

In one example, a first sensor of a first machine may determine parameters indicative of a first production metric during execution of a first task, and a second sensor of a second machine may determine parameters indicative of a second production metric different from the first production metric during execution of a second task different from the first task. The first and second sensors may be any sensors associated with the machines 102, 104, 105, 106, 107 that may detect a production metric of the machines directly or indirectly. For example, the sensors may include the location sensors 130 that detect the location of the machines. Being able to detect the location of the machines allows for a production metric associated with distances traveled and area covered by the machines 102, 104, 105, 106, 107 to be obtained and for confirming whether the tasks have been completed. For example, a compacting machine 105 and/or a grading machine 107 may be used to cover the work surface 110 of the worksite 112 in a sequential manner moving back and forth across what may be an entirety of the work surface 110 in order to uniformly grade and compact the entirety of the work surface 110. Thus, data obtained from the location sensor 130 of the compacting machine 105 may define the production metric of the compacting machine 105 and define when the task associated with the compaction of the material 118 has been completed.

As another example, the sensors may include a weight sensor that may be included within, for example, a digging machine 102, a loading machine 104, and/or a hauling machine 106. The weight sensor may determine a weight of the material such as the soil 118 that is lifted and carried by the digging machine 102, the loading machine 104, and/or the hauling machine 106. In this example, the sensor may indicate that the weight of the material 118 has been unladen from the machine 102, 104, 105, 106, 107, and the system controller 122 may identify that unlading of the material 118 as a completion of a task. In the above examples of sensor-bound machines 102, 104, 105, 106, 107, although two sensors are described, any number of sensors may be used within the individual machines, and any number of machines 102, 104, 105, 106, 107 may include sensors to detect parameters of those machines indicative of their respective production metrics.

At 306, the system controller 122 may receive telematics data from the machines 102, 104, 105, 106, 107 corresponding to the tasks assigned to the machines 102, 104, 105, 106, 107, and associate the telematics data with the production metrics from the machines 102, 104, 105, 106, 107 within a segmented portion of the worksite 112. The telematics data may be measured by the sensors, transmitted by the controllers 136 within the machines 102, 104, 105, 106, 107, and received by, for example, the system controller 122. Thus, the data received by the system controller 122 defines the sensed data and is transmitted at a distance, by electrical translating means such as a wired or wireless communication network including the network 124. The association of the telematics data with the production metrics may be performed using, for example, data maps, look-up tables, neural networks, algorithms, machine learning algorithms, and/or other components.

At 308, the system controller 122 may calculate and/or otherwise determine a lift count based on the machine telematics data received from the machines 102, 104, 105, 106, 107. The machine telematics data may be used by the system controller 122 to identify when the two or more tasks that make up the lift count are completed. In the examples described herein, the two or more tasks include a material delivery task, a material spreading task, and a material compacting task. When confirmation is received by the system controller 122 that the three tasks have been performed based on the machine telematics data, the system controller 122 enumerates a lift count. Any number of lift counts may indicate a level of completion of the worksite plan. For example, if the worksite plan includes approximately 100 lifts, a lift count of 10 would indicate that the worksite plan has a 10% completion level with approximately 90 lifts (90%) left in the worksite plan. Further, because the worksite 112 may include a plurality of zones where the material is to be placed, lift counts for individual zones may also be measured.

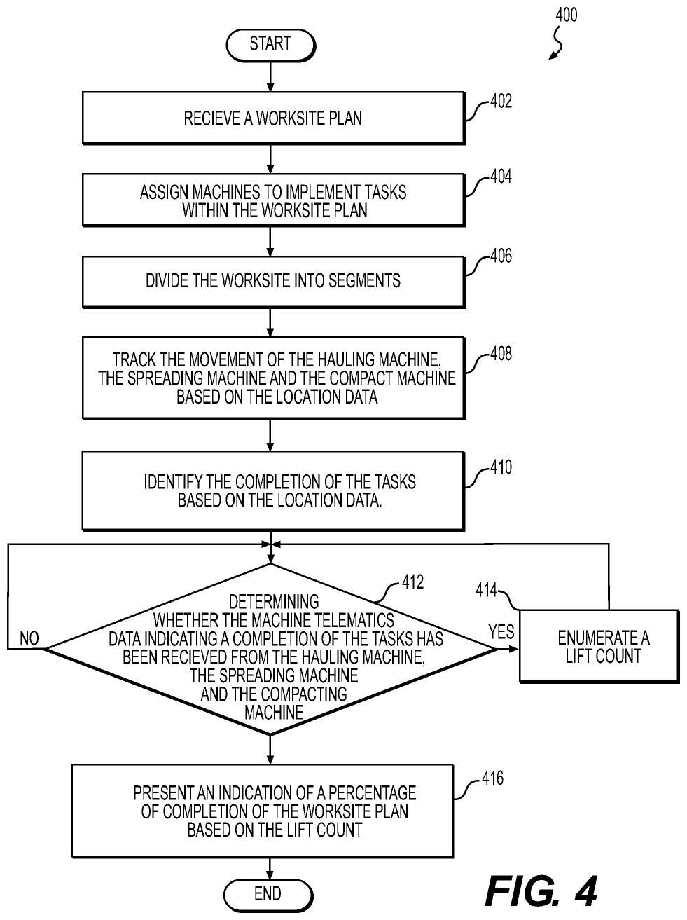

FIG. 4 is a flow chart depicting an example method 400 associated with the systems and methods shown in FIGS. 1 and 2. At 402, a controller, such as the processing and memory architecture of the system controller 122 of the control system 120, may receive a worksite plan to be executed by the machines 102, 104, 105, 106, 107 at a worksite as described herein. Further, at 404, the system controller 122 may assign the machines 102, 104, 105, 106, 107 to implement the tasks worksite plan as described herein.

The system controller 122 may divide the worksite 112 into segments at 406. For example, the work surface 110 of the worksite 112 may be divided geographically into square meters (m²) or other units of area. As the machines 102, 104, 105, 106, 107 work within a given geographic division of the worksite 112, the system controller 122 may determine whether the sequence of a hauling task, a spreading task, and a compacting task that make up a lift has occurred. Once these tasks have occurred in order in the given geographic division of the worksite 112, the lift is considered complete and is enumerated within the lift count metric.

Thus, at 408, the movement of the machines involved in the material hauling task (i.e., the digging machines 102, the loading machines 104, and the hauling machines 106), the machines involved in the material spreading task (i.e., the grading machines 107), and the machines involved in the material compacting task (i.e., the grading machines 107 and the compacting machines 105) may be tracked. In one example, the location data obtained from the machines 102, 104, 105, 106, 107 as machine telematics data may be used by the system controller 122 to track the machines 102, 104, 105, 106, 107 within and outside the worksite 112.

The system controller 122 may identify the completion of the tasks at block 410 based on the location data tracked at 408. The location data may be tracked by the location sensors 130 for the machines 102, 104, 105, 106, 107 and may be sent via the communication devices 126, the central station 108, and/or the network 124 to the system controller 122.

The system controller 122, may determine whether the machine telematics data has been received from the machines 102, 104, 105, 106, 107 including the material delivery machines (i.e., the digging machines 102, loading machines 104, and hauling machines 106), the material spreading machines (i.e., the grading machines 107), and the material compacting machines (i.e., the grading machines 107 and the compacting machines 105). The machine telematics data indicates a completion of the tasks within the worksite plan.

In response to a determination that the machine telematics data has been received (block 412, determination YES), the system controller 122 enumerates a lift count at block 414 and the method returns back to before 412 to determine if additional lift counts are to be enumerated. In response to a determination that the machine telematics data has not been received (block 412, determination NO), the system controller 122 returns back to before 412 to determine if additional lift counts are to be enumerated. In this manner, when a lift count has been achieved, it may be enumerated accordingly.

At 416, an indication of a percentage of completion of the worksite plan may be presented based on the lift count obtained from 412 and 414. The lift count may be presented on a user interface such as those provided by the display devices of the electronic devices 128 within the system 100. A graphical user interface (GUI) may be presented on the display devices of the electronic devices 128 such that the lift count is presented as a portion, fraction, or percentage of the worksite plan. This allows users of the system 100 to quickly determine a level of completion of the worksite plan.

### INDUSTRIAL APPLICABILITY

The present disclosure describes systems and methods for obtaining a lift count metric that designates a level of completion of a number of tasks within a worksite plan and the worksite plan as a whole. Such systems and methods may be used to more efficiently present to a user a level or percentage of completion of the worksite plan and a plurality of tasks such that the user may fully understand how efficiently the worksite plan is being performed. The systems and methods coordinate activities of one or more the digging machines 102, loading machines 104, and hauling machines 106 (i.e., as material delivery machines), grading machines 107 (i.e., as material spreading machines), and the grading machines 107, the compacting machines 105 (i.e., as material compacting machines), and/or other components of the system 100 during execution of the worksite plan and/or other operations at the worksite 112. For example, such systems and methods may enable a system controller 122 to obtain machine data and use the machine data to calculate and/or otherwise determine the lift count. The system controller 122 may also present a representation of the unifying production metric to a number of users via at least one user interface. Thus, users may be able to be notified of and readily understand a level or percentage of completion of the worksite plan and the tasks included in the worksite plan.

As a result, the systems and methods of the present disclosure may assist in reducing the time and resources required to perform various tasks at the worksite 112 and within the worksite plan by assisting users with a more effective understanding of the progress of the various machines utilized within the worksite plan. The systems and methods of the present disclosure may also assist a user in determining what machines or groups of machines may be functioning less efficiently. As a result, the systems and methods of the present disclosure may allow a user to correct any inefficiencies and reduce the time in may take to complete the worksite plan and allow for the meeting of expected deadlines or timelines. Thus, a lift count may assist a user in understanding a complete level or percentage of a worksite plan. With this understanding, the user may be able to execute the worksite plan in an efficient manner. The disclosed systems and methods may facilitate the determination and presentation of a lift count metric.

While aspects of the present disclosure have been particularly shown and described with reference to the examples above, it will be understood by those skilled in the art that various additional examples may be contemplated by the modification of the disclosed machines, systems and methods without departing from the spirit and scope of what is disclosed. Such examples should be understood to fall within the scope of the present disclosure as determined based upon the claims and any equivalents thereof.

What is claimed is:

1. A method of estimating productivity of different types of machines operating in a constrained area at a worksite, comprising a controller configured to perform the following operations:
receiving, a worksite plan to be executed by a hauling machine, a spreading machine, and a compacting machine at the worksite;
assigning, the hauling machine, the spreading machine, and the compacting machine to implement tasks defined by the worksite plan based on respective capabilities of the hauling machine, the spreading machine and the compacting machine;
receiving, machine data from the hauling machine, the spreading machine, and the compacting machine, the machine data being indicative of a first level of completion corresponding to a first task being performed by the hauling machine, a second level of completion corresponding to a second task being performed by the spreading machine, and a third level of completion corresponding to a third task being performed by the compaction machine; and
determining, a lift count based on the machine data.

2. The method of claim 1, further comprising presenting, with the controller and on a user interface, an indication of a percentage of completion of the worksite plan based on the lift count.

3. The method of claim 1, wherein the machine data includes location data defining locations of the hauling machine, the spreading machine, and the compacting machine during execution of the first task, the second task, and the third task.

4. The method of claim 3, wherein determining the lift count includes:
dividing the worksite in to segments;
tracking movement of the hauling machine, the spreading machine, and the compacting machine based on the location data; and
identifying completion of the first task, the second task, and the third task based on the location data.

5. The method of claim 4, wherein the lift count includes a measure of a lift height defined by a depth of a material deposited and compacted within the segments of the worksite.

6. The method of claim 1, wherein assigning, with the controller, the hauling machine, the spreading machine, and the compacting machine to implement the tasks defined by the worksite plan based on the respective capabilities of the hauling machine, the spreading machine and the compacting machine includes:
identifying a type of machine of the hauling machine, the spreading machine and the compacting machine, the type of machine defining the capabilities of the hauling machine, the spreading machine and the compacting machine;
identifying the first task, the second task, and the third task assigned to the hauling machine, the spreading machine and the compacting machine, respectively; and
assigning the hauling machine, the spreading machine, and the compacting machine based on the capabilities, and the identified first task, the second task, and the third task.

7. The method of claim 6, wherein determining the lift count includes:
determining whether the machine data indicating a completion of the first task, the second task, and the third task has been received from the hauling machine, the spreading machine, and the compacting machine, respectively;
in response to a determination that the machine data has been received, enumerating the lift count; and
enumerating a plurality of lift counts in instances wherein a subsequent determination that the machine data has been received,
wherein the plurality of lift counts define a percentage of completion of the worksite plan.

8. A system for measuring productivity across different types of machines comprising:
a controller;
a first machine of a first type operable at a worksite to perform a first task defined by a worksite plan;
at least a second machine of a second type operable at the worksite to perform a second task defined by the worksite plan; and
a communication network configured to transmit signals between the controller and the first machine and the second machine, the controller being configured to:
receive, from a first sensor associated with the first machine, first machine data defining an indication of completion of the first task from the first machine;
receive, from a second sensor associated with the second machine, second machine data defining an indication of completion of the second task from the second machine; and
determine a lift count based on the first machine data and the second machine data, the lift count defining a percentage of completion of the worksite plan.

9. The system of claim 8, wherein the lift count includes a plurality of lift counts, a number of the plurality of lift counts defining the percentage of completion of the worksite plan.

10. The system of claim 9, wherein the controller is further configured to present, on a user interface, an indication of the percentage of completion of the worksite plan based on the plurality of lift counts.

11. The system of claim 8, wherein the first machine and the second machine includes:
the first machine of the first type to perform the first task within the worksite plan;
the second machine of the second type to perform the second task within the worksite plan; and
a third machine of a third type to perform a third task within the worksite plan, the third machine including a third sensor to transmit third machine data defining an indication of completion of the third task from the third machine,
wherein calculating the lift count includes:
receiving the first machine data, the second machine data, and third machine data received from a third sensor associated with the third machine defining indication of completion of a third task by the third machine; and
calculating the lift count based on the first machine data, the second machine data, and the third machine data.

12. The system of claim 11, wherein:
the first machine includes a hauling machine to haul material to and within the worksite, the first task including a hauling instance;
the second machine includes a spreading machine to spread the material within the worksite, the second task including a spreading instance; and
the third machine includes a compacting machine to compact the material within the worksite, the third task including a compacting instance.

13. The system of claim 12, wherein the first machine, the second machine, and the third machine include a communication device to transmit the first machine data, the second machine data, and the third machine data to the controller.

14. The system of claim 12, wherein:
the first sensor of the first machine includes a first location sensor to track a location of the first machine during execution of the first task, and
the second sensor of the second machine includes a second location sensor to track a location of the second machine during execution of the second task,
the third sensor of the third machine includes a third location sensor to track a location of the third machine during execution of the third task, and
the controller determines the lift count based at least partially on location data obtained from the first location sensor, the second location sensor, and the third location sensor.

15. The system of claim 14, wherein, with the controller, calculating the lift count includes:
dividing the worksite into a plurality of segments;
tracking movement of the hauling machine, the spreading machine, and the compacting machine based on the location data within the segments; and
identifying completion of the first task, the second task, and the third task based on the location data and movement of the hauling machine, the spreading machine, and the compacting machine between the segments.

16. A system for determining a percentage of completion of a worksite plan:
a controller; and
a communication network communicatively coupled to the controller to transmit signals between the controller and a plurality of machines;
the controller to:
receive, from a first sensor associated with a first machine, first machine data defining an indication of completion of a first task;
receive, from a second sensor associated with at least a second machine, second machine data defining an indication of completion of a second task; and
determine a lift count based on the first machine data and the second machine data, the lift count defining a percentage of completion of the worksite plan.

17. The system of claim 16, further comprising receiving, from a third sensor associated with a third machine, third machine data defining an indication of completion of a third task.

18. The system of claim 17, wherein:
the first task includes a material delivery task,
the second task includes a material spreading task, and
the third task includes a material compacting task,
wherein the lift count is defined by completion of the first task, the second task, and the third task.

19. The system of claim 18, wherein determining the lift count includes:
determining whether the machine data indicating a completion of the first task, the second task, and the third task has been received;
in response to a determination that the machine data has been received, enumerating the lift count; and
enumerating a plurality of lift counts in instances wherein a subsequent determination that the machine data has been received,
wherein the plurality of lift counts define the percentage of completion of the worksite plan.

20. The system of claim 17, wherein the controller is further configured to:
divide a worksite associated with the worksite plan into a plurality of segments;
track movement of the first machine, the second machine, and the third machine within the segments based on location data defined in the first machine data, the second machine data, and the third machine data;
identify completion of the first task, the second task, and the third task based on the location data and movement of the first machine, the second machine, and the third machine between the segments; and
determine the lift count based on the completion of the first task, the second task, and the third task.
